(19) United States
(12) Patent Application Publication
(10) Pub. No.: US 2017/0305023 A9
(43) Pub. Date: Oct. 26, 2017

(54) SHAVING SYSTEMS WITH RAZOR BLADE USAGE TRACKING

(71) Applicants: Lamar Ball, Denton, TX (US); Wojciech Grohman, Little Elm, TX (US)

(72) Inventors: Lamar Ball, Denton, TX (US); Wojciech Grohman, Little Elm, TX (US)

(21) Appl. No.: 14/554,048

(22) Filed: Nov. 26, 2014

Related U.S. Application Data
(60) Provisional application No. 61/909,484, filed on Nov. 27, 2013.

(51) Int. Cl. B26B 21/40; B26B 21/52

(52) U.S. Cl. CPC B26B 21/4056; B26B 21/526

(57) ABSTRACT

A razor handle including a handle body and a mechanism for tracking usage of a razor blade or razor blade cartridge. The tracking mechanism includes means to identify a unique razor blade cartridge attachment to the handle body and electronic circuitry disposed within the handle body for automatically tracking razor blade or razor blade cartridge use. The collected data is then sent out to and stored at a remote server.

### RELATED APPLICATIONS

This application claims benefit of and priority to Provisional Patent Application No. 61/909,484, filed Nov. 27, 2013, incorporated by reference herein.

### FIELD OF INVENTION

The present invention relates in general to personal care appliances, and in particular to shaving systems with razor blade usage tracking.

### BACKGROUND OF INVENTION

The typical commonplace razor includes a handle and a cartridge carrying one or more blades for shaving whiskers or hair from the body. After a certain amount of use, the blades become too dull for shaving and the cartridge must be discarded and replaced with a new cartridge with sharp blades. However, even though it is common knowledge that a razor cartridge has a particular usage lifetime before it must be replaced, the typical consumer does not carefully track his or her razor cartridge usage. As a result, cartridges with blades that are still sufficiently sharp for comfortably obtaining a good shave are often discarded too early or cartridges that are too dull continue to be used, albeit with reduced comfort, less than desirable results, or both.

### SUMMARY OF INVENTION

According to the principles of the present invention, a razor handle is disclosed, which includes electronic circuitry to keep track of cartridge usage. A mechanical reset mechanism may also be provided, which automatically resets the shaving event count when a new cartridge is attached to the handle. The reset mechanism may include one or more spring loaded prongs, prong receptacles, or a combination of prongs and prong receptacles, which are actuated when a new cartridge pushes-on, or is received by, the handle. Some embodiments of the present principles include, in addition to the shaving event counter, or as an alternative thereto, storing the date a new blade cartridge is installed and track the amount of time the cartridge is used.

Embodiments of the present principles are also embodied in a razor handle that contains electronic circuitry, which counts the number of shaving events and detects the timeframe each razor blade is used. In one particular embodiment, individual razor blades or entire cartridges are equipped with an electronic ID to allow the electronic circuit inside of the blade to positively identify that blade or cartridge. The electronic ID may be analog in nature (e.g., a circuit or structure that varies impedance between two points of a given razor blade), or digital (e.g., an encoded number accessed via a serial connection between the cartridge and razor handle). In some particular embodiments, the electronic ID is transmitted wirelessly using a very low power near field communication system (similar to NFC tags) between the cartridge and the handle and or to a nearby counter/display device.

Alternatively, the razor blades come equipped with a mechanical ID to allow the electronic circuit inside of the handle to positively identify each cartridge. The mechanical ID may have any form, including, for example multiple prongs and/or prong receptacles on the cartridge whose presence, or lack of it, indicates a unique number, or prongs and/or prong receptacles of various shapes disposed on the cartridge that can be detected by the matching mechanism on the razor handle.

The various embodiments of the principles of the present invention provide substantial advantages over the prior art. Among other things, they allow a user to easily and accurately gauge the wear on the razor blades and replace the blade or blade cartridge as necessary. As a result, the probability of prematurely replacing and disposing of usable razor blades and blade cartridges is substantially reduced. In turn, the user receives the maximum value from their razor blades and cartridges while still obtaining comfortable and effective shave.

### BRIEF DESCRIPTION OF DRAWINGS

For a more complete understanding of the present invention, and the advantages thereof, reference is now made to the following descriptions taken in conjunction with the accompanying drawings, in which:

FIG. 1 shows an example razor body with an attached razor cartridge representative of the principles of the present invention;

FIG. 2 is a diagram representing an illustrative embodiment of the attachment mechanism between the razor handle and razor cartridge of the present invention;

FIG. 3 is a diagram of a representative embodiment of the electronic circuitry disposed within the razor handle of the present invention, which uses electronic circuitry within the razor handle to detect and record information related to razor blade/razor blade cartridge use;

FIG. 4 is a diagram of a representative system of the principles of the present invention using one or more intermediate devices to exchange the data between the razor handle and the remote data server;

FIG. 5 shows a diagram of the method of the present invention, which uses electronic circuitry within the razor handle to detect and record information related to razor blade/razor blade cartridge use and send the collected data to a remote server.

### DETAILED DESCRIPTION OF THE INVENTION

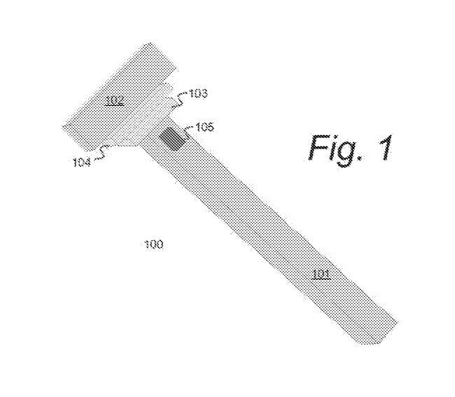

The principles of the present invention and their advantages are best understood by referring to the illustrated embodiment depicted in FIGS. 1-5 of the drawings, in which like numbers designate like parts.

FIG. 1 is a representation of an exemplary razor assembly 100 including the razor handle 101 and the razor blade cartridge 102. The attachment of the cartridge to the handle is facilitated by the handle attachment interface 103 and the razor blade cartridge attachment interface 104. The handle attachment interface 103 is a part of the razor handle 101 and the razor blade cartridge attachment interface 104 is a part of the razor blade cartridge 102. The attachment mechanism allows for separation of the razor handle from the razor blade cartridge thus facilitating replacement of either one. The electronic circuitry to track the usage of the razor handle 101 and attached razor blade cartridge 102 is disposed within the handle 101.

In some embodiments, there is an optional cartridge release button 105 facilitating easy detachment of the razor blade cartridge 102 from the razor handle 101. The button could be a mechanical lever, a button, a push slider or the like. The activation of cartridge release button 105 can signal to the electronic circuitry disposed within the handle 101 that the existing cartridge is being removed thus potentially triggering the mechanism to check if a cartridge is presently attached and if so, if it is a newly added cartridge or the previously attached one. In other words, the detection of the new razor blade being attached to handle 101 may be achieved by the activation of a mechanical release button 105 that causes the razor cartridge attachment to become loose, the subsequent detection of the attachment of a blade or blade cartridge, or both.

It should be obvious to the ones skilled in the art that the shape and the size of both the razor handle and razor blade cartridge and all their subcomponents shown in FIG. 1 are one of many possible embodiments of the presented invention. The razor blade cartridge can have a single mechanical blade disposed within it, or any other number of mechanical blades. It can further contain other electronic means of shaving such as laser light, electric voltage, electric current, etc. It can also contain chemical agents to facilitate hair removal. In short, the razor blade cartridge may contain no actual blades, or it can contain a number of them. It is main characteristic is that it has a limited lifespan and therefore needs to be replaced at some time and that it facilitates shaving or any other purpose related to skin or hair care. One such possible device is a set of electrical clippers whose usage of attached blades or hair length guides may be tracked.

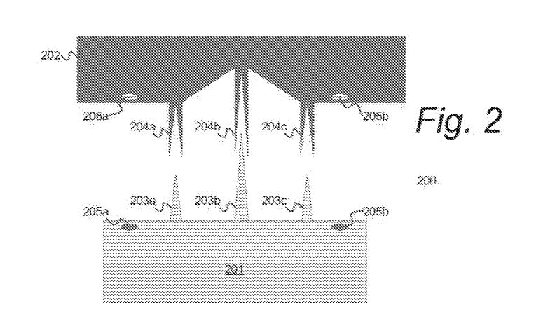

A critical component of the razor assembly is the attachment interface between the razor handle 101 and the razor cartridge 102. An example embodiment of such attachment interface is shown in FIG. 2.

The attachment interface 200 connects a side 201 of the handle body 101 to a side 202 of the razor blade cartridge 102. Disposed on the side 201 are three prongs 203a, 203b and 203c. The prongs are designed to mate to the prong receptacles 204a, 204b and 204c, respectively. The receptacles 204a through 204c are disposed on the side 202 of the razor blade cartridge 102. The prongs and the prong receptacles form a locking mechanism that keeps the razor blade cartridge attached. They may be used as a mechanical identification mechanism of the different razor blade cartridges being attached to the handle body. For example a varying number of prong receptacles or their varying length can be used to determine a number associated with the attached razor blade cartridge. This number is representative of the unique identifier associated with the razor blade cartridge and detected by the electronic circuitry disposed within the razor handle 101.

The prong and prong receptacle pairs can further be used to facilitate electrical or magnetic connection between two different parts of electrical or magnetic detection mechanism, one disposed on the razor blade cartridge 102 and the other disposed within the razor handle body 101. Additionally, the electronic or magnetic circuit connection points can be separate from the attachment mechanism as shown with connection pairs 205a, 206a and 205b, 206b. The connections 205a and 205b disposed on the razor body side 201 form an electric or magnetic connection with the matching connections 206a and 206b disposed within the razor blade cartridge side 202. While only two connections are shown, any number of them is possible.

There are different electrical characteristics that can be used to uniquely mark a cartridge. For example, a resistance between points 206a and 206b can be used. Different cartridges would have different resistance values between these two points thus allowing for a wide array of unique numbers representing a large number of unique razor blade cartridges. Clearly, if more connections are used, the larger the pool of possible identifiers. These multiple identifiers need not to have two separate connections each, but they can rather share the common or other electrical connections thus reducing the complexity and cost of the razor blade cartridge and the razor handle.

Other electrical connection identifiers include capacitance, inductance, the filter time constant or any combination of all of these. The capacitance identifier may only need one connection and not require a direct mechanical connection. This may be preferred as a more reliable connection in the water exposed environment as usually encountered during the act of shaving. Similarly, the inductive coil or a magnet disposed within the razor blade cartridge can be used.

Another way to uniquely identify the razor blade cartridge is to embed within it a digital circuit that is programmed with a unique identifier representative of a unique razor blade cartridge. This number could be the manufacturing serial number, series number, the date code, or the like. The digital number can then be transmitted via one of afore mentioned connections of the attachment interface, or sent wirelessly to the razor body. The number can be stored in form of the near field communications tag or any other form allowing for low power wireless detection and read out of it.

All these different unique identifiers can be used separately or in combination of one with another. Other identifiers can be used as well. The main requirements being that they are easy to embed within the razor blade cartridge, are inexpensive to manufacture, are robust and reliable. It is also possible to use any combination of different identifiers and they can be redundant to further improve the reliability of proper razor blade cartridge identification by the electronic circuitry disposed within the razor handle body 101.

Water, shaving lubricant or any other substance can be used as an electric connection, thus reducing the number of needed dedicated electrical connections between the razor blade cartridge and the razor handle. Thus, a minimum number of needed dedicated connections on the razor is one. However, to correctly identify the attached razor blade cartridge with the help of electronic circuitry, it is preferred to have at least two electrical connections thus facilitating the unique identification reading even when the razor assembly is not being used.

The fact that three prongs and prong receptacle pairs are shown in the figure, should not be considered in any way a limiting factor. Any number, including none, of prong and prong receptacles pairs can be used in the attachment mechanism. It should also be understood that the location of prongs on the razor handle and prong receptacles on the razor blade cartridge is just one particular embodiment. There is no limitation on using prongs only on one side of the attachment interface. Any combination of prongs and prong receptacles can be disposed on both the handle body and the razor blade cartridge with the only requirement being that they mate together allowing for the attachment of the razor blade cartridge to the razor handle. It should also be understood that many other attachment mechanisms exist and they all can be used, separately or in a combination with one another, in the disclosed invention.

It should further be understood by those skilled in the art that the attachment interface 200 shown in FIG. 2 is just one example of many possible embodiments of similar interfaces and it should not be construed to be a limitation on the principals of the disclosed invention.

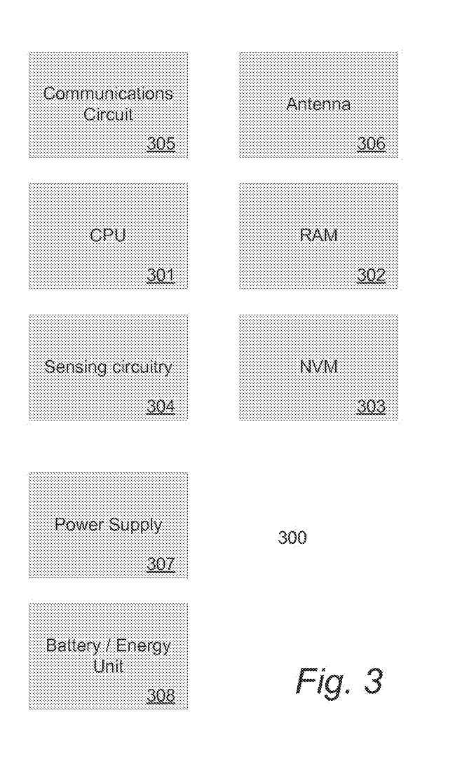

The block diagram shown in FIG. 3 is a representation of the electronic circuit 300 used for tracking the razor cartridge usage disposed within the razor handle body 101. The circuit's Central Processing Unit 301 uses the Random Access Memory 302 associated with it to temporarily store variables and data as required by the application program stored in the Non-Volatile Memory 303 and executed by the CPU. The NVM 303 contains the program as well as data and can be implemented as one or more chips. It can be implemented using flash data storage such as NAND or NOR flash, EEPROM, Magnetic RAM or any other technology allowing for data storage when not powered up.

The sensing circuitry 304 is used to detect whether a razor blade cartridge is attached to the razor handle and what its unique identifier is. The particular circuits contained within it facilitate various methods of razor blade cartridge identification as described above. These may include the analog and/or digital circuits to measure resistance, capacitance, inductance, filter time constant, digital ID, etc. The sensing circuitry may further include sensors to detect attachment/detachment of the razor blade cartridge, motion of the razor handle, moisture on the razor handle assembly, and any other circuitry needed to sense shaving type and measure the duration of razor usage.

The electronic circuit 300 is further equipped with a communications circuit 305. The communications circuit 305 can support either wired, or preferably, wireless mode of communications. In the later case, it contains a wireless radio and is associated with the shown antenna 306. The communications circuit 305 is used as a transmitter to send the usage data to a nearby receiver. It may also optionally be used as a receiver to further improve the quality and robustness of the communication with an external device. The external device in communication with the razor handle may be a smart device such as a smart phone or tablet, a wireless router, hub or any other electronic device with means to facilitate communication between the razor handle and a remote server.

There is no limitation on the mode of the wired or wireless transmission employed to communicate with the external device, but it is preferred to be a wireless low power solution, such as a low power local area network (LAN), commonly referred to as WiFi, any network based on one of the IEEE 802.11 family of standards, low power personal area network (PAN), such as one based on the IEEE 802.15.4 or IEEE 802.15.5 standards, or one of the family of the Bluetooth communications standards, such as Bluetooth Low Energy.

The electronic circuit 300 also contains the power supply 307 which powers the electronics. The power supply uses a battery/energy unit 308 to store and harvest energy needed. The battery contained within it may be a any or all of the following: (1) a built-in rechargeable battery, preferably a lithium, or lithium ion, or lithium polymer battery; (2) a replaceable battery, such as a single AAA or AA type alkaline or lithium battery; (3) a flywheel energy storage system or (4) system for kinetic energy harvesting, such as one based on the Texas Instrument CC430 platform.

Using the circuitry described, the razor handle 101 senses a new cartridge 102 through a cartridge identifier (ID) carried by razor blade cartridge 102, which could be, for example, any type of mechanical unique identifier or any type of an electronic unique identifier.

The electronic circuit 300 also tracks razor usage by time, number of shaving events, or both time and number of shaving events. In one embodiment, the circuitry senses at least two-axis motion of razor handle 101 with a blade cartridge 102 attached and lasting longer than a predefined period, e.g., 15 to 30 seconds. (When the cartridge is not attached to razor handle 101, any detected motion is not considered to be a shaving event.) Alternatively, electronic circuit 300 detects moisture on razor cartridge 102. (Detection of moisture can also be made by blade cartridge 102 itself, either attached to or detached from, razor handle 101.) Further embodiments of razor handle 101 detect the higher temperature on razor handle 101 indicative of a human hand touching the handle (with cartridge attached) for a duration longer than a predefined period (e.g., 15 to 30 seconds) or by detecting the proximity of a human hand via a capacitive sensor for a duration longer than a predefined period (e.g., 15 to 30 seconds).

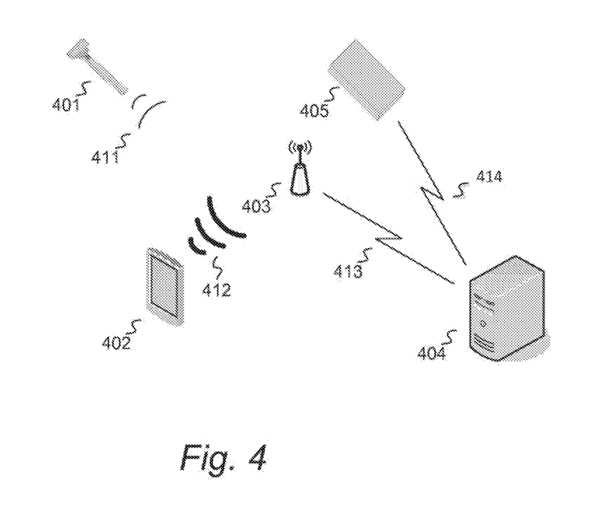

The external communication of the data collected by the razor handle is shown in FIG. 4. In case of wireless communication, the razor assembly 401 is in communication with a device 402 or the wireless hub 403 using the wireless connection 411. The device 402 is a device that is not fixed to one position and it is in communication with the wireless hub 403 using wireless connection 412. The wireless hub 403 is located in a fixed position, usually powered from an external source, such as AC power. It is in communication with a remote server 404 using data connection 413. In case of the wired mode of communication, the razor assembly 401 is in wired communication with the optional razor handle cradle 405 when attached to it. The wireless connections 411 and 412 can be independent of each other and support different or the same mode of communication. The data connection 413 represents a logical connection over which the data is sent from the wireless hub 403 to the remote server 404. This connection may have multiple physical and virtual intermediaries and be implemented in any way possible as long as it supports the data exchange between wireless hub 403 and the remote server 404. Similarly, the data connection 414 represents a logical connection over which the data is sent from the razor base 405 to the remote server 404. This connection may have multiple physical and virtual intermediaries and be implemented in any way possible as long as it supports the data exchange between razor base 405 and the remote server 404.

The wireless device 402 can be any type of an electronic device able to communicate with the razor assembly 401 and facilitating its communication with a remote server 404. A typical example of device 402 can be a smart device such as smart phone or tablet, a laptop computer, etc. The wireless hub 403 can be a wireless hub, a cellular network tower, a wireless local area network router, a wide area network router, or any other device that acts as an intermediary to transmit data between the razor assembly 401 and the remote server 404.

The preferred embodiment of handle 101 of the razor assembly 401 includes embedded electronic circuitry supporting communications with a wireless or wired network, thereby allowing upload any or all of the collected data to a remote server 404, such as a cloud-based server. The uploaded information could be used by the user, for tracking personal cartridge use and determining the time for cartridge replacement, or by a razor manufacturer or its partners, for use in globally analyzing cartridge use and replacement habits of a group of participating users.

In one particular embodiment, razor handle 101 operates in conjunction with a matching razor base 405 that facilitates wireless or wired communications to the remote server over a data connection 414. Suitable wireless communications modes include: (1) a Personal Area Network, such as one based on the IEEE 802.15.4 specification, including but not limited to Zigbee; (2) a LowPAN network; (3) Low power local communication protocol such as one based on any of the Bluetooth communication standards; (4) a DASH7 protocol network; (5) a Z-wave network; and/or (6) another wireless network including proprietary networks. The wireless communications may be carried over any one of proprietary, limited use (such as the 5.0 GHz band) or any one of the ISM frequency bands such as the 40 MHz, 433 MHz, 915 MHz, 2.4 GHz, and 5.8 GHz, among others.

Razor handle 101 and/or razor base 405 may also communicate with compatible devices within their vicinity, including any wireless routers and access points on a nearby PAN or LAN that can serve as a medium for Internet communications. These communications are preferably based on one or more of: (1) a Near Field Communications technology, such as one based on the ISO/IEC 18092/ECMA-340 and/or ISO/IEC 21481/ECMA-352 standards; (2) a device or system in accordance with the IEEE 802.15.4 specification, including but not limited to Zigbee, Threshold or 6LowPAN network; (3) a low power local communication protocol such as one based on any of the Bluetooth communication standards; (4) a DASH7 protocol network; (5) a Z-wave network; and/or another wireless network including proprietary networks.

Alternatively, razor handle 101 and razor base 405 communicate with a local area network (LAN) via a Power Line Communication technology, such as one based on the on IEEE 1901 standard, the HomePlug specifications, or the like.

The razor handle 101 may also include a display (not shown), which could alternatively be disposed on razor base 405. The display is preferably a OLED or LCD type display and displays information including one or more of the number of shaving events for the current cartridge, the number of total shaving events for the razor handle, the date the razor handle was first used, the date the current cartridge was installed, the total usage time of the current cartridge, and/or the total usage time of the razor handle, or any additional usage information that is helpful in tracking the razor blade cartridge remaining life/capacity left.

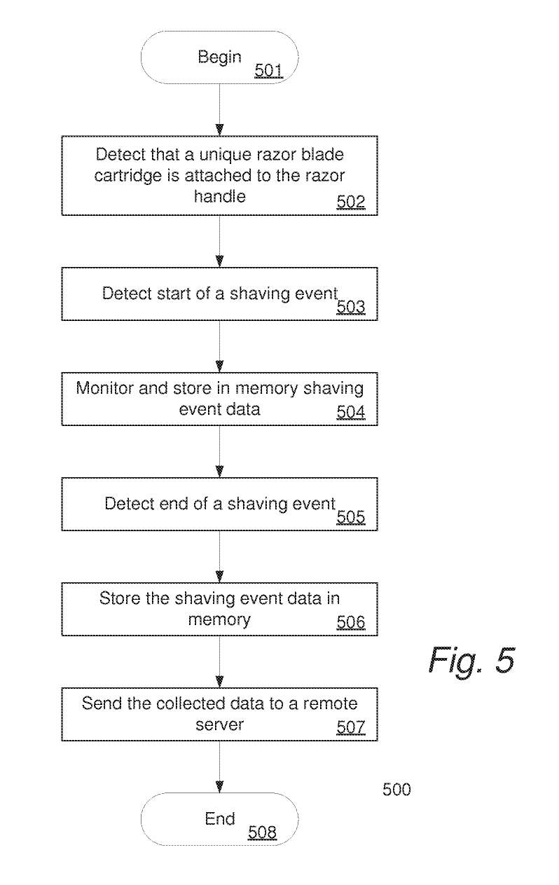

FIG. 5 shows a method 500 of tracking the razor usage. The method starts at the step 501. In the step 502 the method determines that a unique razor blade cartridge is attached to the razor handle. In the following step 503, the method detects the start of a shaving event. In the ensuing step 504, the method starts to monitor and store any data related to the shaving event. The data is stored in any memory associated with the circuit 300, such as the RAM 302 or the NVM 303, or both. In the following step 505 the method determines that the shaving event is finished. In the next step 506 the rest of the shaving event data is stored in afore mentioned memory. After the step 506 the method transits, when communication data transmission is possible, to step 507.

It should be understood, by those skilled in the art, that the data transmission in step 507 may include data collected during one or many shaving events, or the data may indicate lack of shaving events. If the intermediary non-fixed device 402 is used, the step 507 may be repeated as often as the device 402 comes within the communicating range of the razor assembly 401 to allow for the communications mode 411 to be effective. Similarly, when the razor assembly 401 is within the communication range of the wireless hub, the transmission in step 507 is possible and may happen at any time including regularly scheduled hourly, daily, weekly or monthly times, or preferably, after a shaving event is completed. Even in the case of continuously available reliable wireless communication, it may be preferable to aggregate data from a number of shaving events before transmitting the data out of the razor assembly 401 to preserve the energy stored within the battery/energy unit 308.

In the step 507, the data is send by the razor handle circuitry 300 to the remote server 404. In some cases, including, but not limited to, the case of using the optional razor base 405, the data may be transmitted in two separate steps—one from the razor handle 101 to the razor base 405 and then, possibly at a different time, from the razor base 405 to the remote server 404. After the data transmission is concluded, the method ends in the step 508.

Although the invention has been described with reference to specific embodiments, these descriptions are not meant to be construed in a limiting sense. Various modifications of the disclosed embodiments, as well as alternative embodiments of the invention, will become apparent to persons skilled in the art upon reference to the description of the invention. It should be appreciated by those skilled in the art that the conception and the specific embodiment disclosed might be readily utilized as a basis for modifying or designing other structures for carrying out the same purposes of the present invention. It should also be realized by those skilled in the art that such equivalent constructions do not depart from the spirit and scope of the invention as set forth in the appended claims.

It is therefore contemplated that the claims will cover any such modifications or embodiments that fall within the true scope of the invention.

What is claimed is:

1. A shaving razor system comprising:
at least one razor cartridge containing a unique identifier; and
a handle body equipped with electronic circuitry capable of reading the unique identifier of the razor cartridge, when the cartridge is attached to the handle body.

2. The shaving razor system of claim 1, wherein the at least one razor cartridge unique identifier is represented as at least one resistance value between at least two connection points on the cartridge to handle body connector.

3. The shaving razor system of claim 1, wherein the at least one razor cartridge unique identifier is represented as at least one capacitance value at the at least one connection point on the cartridge to handle body connector.

4. The shaving razor system of claim 1, wherein the at least one razor cartridge unique identifier is represented as at least one inductance value between at least two connection points on the cartridge to handle body connector.

5. The shaving razor system of claim 1, wherein the at least one razor cartridge unique identifier is represented as a digital value transmitted to the handle body through at least one connection point on the cartridge to handle body connector.

6. The shaving razor system of claim 1, wherein the at least one razor cartridge unique identifier is represented as an analog filter's time constant value between at least two connection points on the cartridge to handle body connector.

7. The shaving razor system of claim 1, wherein the at least one razor cartridge unique identifier is represented as a mechanical feature of the razor cartridge detectable by the attachment interface on the razor handle body.

8. The shaving razor system of claim 1, wherein the handle body is further equipped with a wireless transmitter capable of sending out usage data collected by the handle body.

9. The shaving razor system of claim 8, wherein the said usage data collected by the handle body includes a representation of the said at least one razor cartridge unique identifier.

10. The shaving razor system of claim 8, wherein the said usage data collected by the handle body includes a representation of the date the said at least one razor cartridge was first attached to the handle body.

11. The shaving razor system of claim 8, wherein the said usage data collected by the handle body includes a representation of the number of shaving events for a specific at least one razor cartridge.

12. The shaving razor system of claim 8, wherein the said usage data collected by the handle body includes a representation of the number of the total duration of shaving events for a specific at least one razor cartridge.

13. A razor handle for use with a razor blade comprising:
a source of electrical power disposed within a body of the razor handle; and
electronic circuitry disposed within the body of the razor handle and operating from the electrical power for tracking usage of the razor blade.

14. The razor handle of claim 13, wherein the electronic circuitry includes a detector for detecting two-axis motion of the razor handle with a razor blade attached for counting shaving events.

15. The razor handle of claim 13, wherein the electronic circuitry includes a detector for detecting moisture on a razor blade attached to the handle for counting shaving events.

16. The razor handle of claim 13, wherein the electronic circuitry includes a detector for detecting a change in temperature of the body of the razor handle for counting shaving events.

17. The razor handle of claim 13, wherein the electronic circuitry further comprises communications circuitry for communicating with an associated compatible device.

18. The razor handle of claim 13, wherein the electronic circuitry comprises a detector for detecting replacement of the razor cartridge.

19. A method to track shaving data comprising:
detecting when a unique razor cartridge is attached to the razor handle;
detecting the start of a shaving event;
detecting the end of a shaving event;
storing the shaving event data in the memory associated with the electronic circuitry contained within the razor handle;
sending the collected shaving event data to a remote server.

20. The method of claim 19 where the said shaving event data comprises any, all or any combination of the following: date and time when the cartridge was first installed, date and time when the cartridge was removed, number of shaving events per cartridge, total duration of the shaving events, start time for each shaving event, duration of each shaving event, average duration of the shaving events.

21. The method of claim 19 where the said sending the collected shaving event data to a remote server from the razor handle is done at least in part wirelessly over a local area network connection.

22. The method of claim 19 where the said sending the collected shaving event data to a remote server from the razor handle is done at least in part wirelessly over a personal area network connection.

23. The method of claim 22 where the said wireless transmission is done over a Bluetooth connection.
